(19) United States
(12) Patent Application Publication
(10) Pub. No.: US 2010/0152428 A1
(43) Pub. Date: Jun. 17, 2010

(54) LOW Tg LIGNIN MIXED ESTERS

(75) Inventors: Angela P. Gifford, Seattle, WA (US); John A. Westland, Auburn, WA (US); Amar N. Neogi, Kenmore, WA (US); Karen D. Ragan, Federal Way, WA (US)

Correspondence Address: WEYERHAEUSER COMPANY;INTELLECTUAL PROPERTY DEPT., CH 1J27, P.O. BOX 9777, FEDERAL WAY, WA, 98063, US

(73) Assignee: WEYERHAEUSER COMPANY, Federal Way, WA (US)

(21) Appl. No.: 12/333,569

(22) Filed: Dec. 12, 2008

(51) Int. Cl. C07G 1/00

(52) U.S. Cl. 530/504; 530/500

(57) ABSTRACT

The disclosure includes lignin mixed esters comprising first ester groups and second ester groups wherein the number of carbon atoms in the first ester group differs from the number of carbon atoms in the second ester group by 3 or more and processes of making the same. The unique thermal glass transition temperature properties of such lignin mixed esters are described.

### TECHNICAL FIELD

The present invention generally relates to lignin mixed ester and process for producing such lignin mixed esters.

### BACKGROUND

Lignin is found in the cell walls of vascular plants and in the woody stems of hardwoods and softwoods. Along with cellulose and hemicellulose, lignin forms the major components of the cell wall of these vascular plants and woods. Lignin acts as a matrix material that binds the plant polysaccharides, microfibrils, and fibers, thereby imparting strength and rigidity to the plant stem. Lignin also acts as a water sealant in the stems of the plant and plays an important part in controlling water transport through the cell wall. It also protects plants against biological attack by hampering enzyme penetration.

Total lignin content can vary from plant to plant. For example, in hardwoods and softwoods, lignin content can range from 15 to about 40%. Due to the widespread availability of lignin from manufacturing processes that focus on recovering polysaccharide components of plants, there has been ongoing interest in the utilization of lignin. Wood pulping is one process for recovering lignin and is one of the largest industries in the world. Various types of wood pulping processes exist, including Kraft pulping, sulfite pulping, soda pulping, and organosolv pulping. Each of these processes results in large amounts of lignin being extracted from the wood. Large amounts of the extracted lignin are generally considered to be waste and are either burned to recover energy or otherwise disposed of. Only a small amount of lignin is recovered and processed to make other products. Efforts have been made to utilize the large availability of industrial lignin. Interest in these efforts is motivated by the wide-spread availability of lignin and the renewable nature of its source. In addition, the biodegradability of lignin makes it attractive from a “green” perspective.

One reported use of lignin is as a co-polymer or polymer additive. For example, it has been suggested that lignin may be useful as a filler material in thermoplastic and thermosetting polymers. Efforts have been made to modify lignin so that its compatibility with polymers can be increased. For example, it has been suggested that modification of hydroxyl groups on the lignin molecule could affect the lignin solubility. When considering utilizing lignin as an additive to thermoplastic or thermosetting polymers, consideration must be given to how the lignin will be incorporated into the polymer. One of the considerations in combining lignin with a polymer is the temperature at which the lignin softens into a pliable material that can be blended with other polymers. Typically, when two polymers are to be blended, it is desired that both polymers have melting points or thermal glass transition temperatures that are similar so that both polymers are pliable and readily combinable with each other at the preferred temperature of processing.

It is reported that softwood Kraft lignin has a thermal glass transition temperature of about 155° C. and hardwood Kraft lignin has a T_{g} of about 106° C. (Kraft Lignin/PEO Blends: Effect of Lignin on Structure and Miscibility and Hydrogen Bonding, Satoshi Kubo, John F. Kadla, Journal of Applied Polymer Science 98:1437-1444, 2005.) It is reported that esterifying the hydroxyl groups of lignin can reduce the glass transition temperature thereof. For example, Ghosh, in his Masters of Science thesis entitled “Blends and Biodegradable Thermoplastics With Lignin Esters” (Apr. 22, 1998, Virginia Polytechnic Institute and University), reports that as the number of carbon atoms in the ester group substituents of a lignin ester increase from 0 to 12, the thermal glass transition temperature for an organosolv lignin decreased from 107° C. to 2° C. Fox, in his May 2006 Masters of Science thesis entitled “Chemical and Thermal Characterization of Three Industrial Lignins and Their Corresponding Lignin Esters” (College of Graduate Studies, University of Idaho), reported that for softwood Kraft lignin and corn stover lignin, as the number of carbon atoms in each ester substituent increased from 2-4, the glass transition temperature decreased.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The lignin mixed esters of the embodiments described herein are derived from a lignin derivative, such as hardwood Kraft lignin, softwood Kraft lignin, or energy crop lignin. The lignin mixed esters include first ester groups represented by the formula —OOCR¹, wherein R¹ is C₁ to C₃ alkyl and second ester groups represented by the formula —OOCR², wherein R² is C₄ to C₁₇ alkyl. The lignin mixed esters are further characterized by having a number of carbon atoms in R² being 3 or more than the number of carbon atoms in R¹ and the ratio of the first ester groups to the second ester groups is less than about 3.

The process embodiments described herein relate to a process for producing a lignin mixed ester from a lignin derivative. The processes described herein include reacting the lignin derivative with a first esterifying agent to introduce first ester groups represented by the formula —OOCR² into the lignin derivative, wherein R¹ is C₁ to C₃ alkyl. The lignin derivative is further reacted with a second esterifying agent to introduce second ester groups represented by the formula —OOCR² into the lignin derivative, wherein R² is C₄ to C₁₇ alkyl. The described processes provide lignin mixed esters wherein the ratio of carbon atoms in R² is 3 or more than the number of carbon atoms in R¹ and the ratio of first ester groups to second ester groups is less than about 3.

In accordance with other embodiments described herein, the lignin mixed ester is a Kraft lignin mixed ester derived from a Kraft lignin derivative. The Kraft lignin mixed ester includes first ester groups represented by the formula —OOCR¹, wherein R¹ is C₁ to C₂ alkyl and second ester groups represented by the formula —OOCR², wherein R² is C₅ alkyl. The Kraft lignin mixed ester includes a ratio of the first ester groups to the second ester groups that is less than about 3 and a degree of esterification that is about 100%. The Kraft lignin mixed esters are characterized by a T_{g} of the Kraft lignin mixed ester that is less than the T_{g} of a Kraft lignin ester having a degree of esterification of about 100%, derived from the Kraft lignin derivative and including ester groups, the ester groups of the Kraft lignin ester being second ester groups.

### DESCRIPTION OF THE DRAWINGS

The foregoing aspects and many of the attendant advantages of the present disclosure will become more readily appreciated as the same become better understood by reference to the following detailed description, when taken in conjunction with the accompanying drawings, wherein:

FIG. 1 is a graph illustrating reported T_{g} of organosolv lignin esters, softwood Kraft lignin esters, and corn stover lignin esters as a function of the number of carbon atoms in each ester substituent as reported in Fox, “Chemical and Thermal Characterization of Three Industrial Lignins and Their Corresponding Lignin Esters,” Masters of Science Thesis, College of Graduate Studies, University of Idaho, May 2006;

FIG. 2 is a graph illustrating T_{g} of a Kraft lignin mixed ester (propionate and hexanoate) wherein the difference in the number of carbon atoms in the ester substituents is 3 or more;

FIG. 3 is a graph illustrating T_{g} of a Kraft lignin mixed ester (acetate and hexanoate) wherein the difference in the number of carbon atoms in the ester substituents is 3 or more;

FIG. 4 is a graph illustrating T_{g} of a Kraft lignin mixed ester (acetate and valerate) wherein the difference in the number of carbon atoms in the ester substituents is 3 or more;

FIG. 5 is a graph illustrating T_{g} of a Kraft lignin mixed ester (acetate and propionate) wherein the difference in the number of carbon atoms in the ester substituents is less than 3;

FIG. 6 is a graph illustrating T_{g} of a Kraft lignin mixed ester (acetate and butyrate) wherein the difference in the number of carbon atoms in the ester substituents is less than 3;

FIG. 7 is a graph illustrating T_{g} of an organosolv lignin mixed ester (propionate and hexanoate) wherein the difference in the number of carbon atoms in the ester substituents is greater than 3; and

FIG. 8 is a graph illustrating T_{g} of an organosolv lignin mixed ester (acetate and hexanoate) wherein the difference in the number of carbon atoms in the ester substituents is greater than 3.

### DETAILED DESCRIPTION

The lignin mixed esters of the embodiments described herein are derived from lignin derivatives originating from lignocellulosic biomass. Hardwood and softwood trees are examples of sources of lignin derivatives from which the lignin mixed esters of the embodiments described herein are derived. Energy crops such as switchgrass, miscanthum, prairie cordgrass, and native reed canary grass are other examples of sources of lignin derivatives that are useful to produce lignin mixed esters of the embodiments described herein. Other sources of lignin derivatives include tobacco, corn stovers, corn residues, corn husks, sugar cane bagasse, castor oil plant, rapeseed plant, soybean plant, cereal straw, grain processing by-products, bamboo, bamboo pulp, bamboo sawdust, rice straw, paper sledge, waste papers, recycled papers, and recycled pulp.

Lignin derivatives are obtained from lignocellulosic biomass using processes designed to separate lignin from the polysaccharide components of the biomass. For hardwoods and softwoods, such processes include the Kraft, organosolv, steam explosion, acid hydrolysis, hydrolytic, soda, and sulfite extraction processes.

Lignin derivatives from other lignocellulosic biomass materials such as energy crops can be obtained by processes such as mild acid extraction, organosolv, steam explosion, and ball milling.

Lignin derivative molecules are derived mainly from three phenylpropane monomers: p-coumaryl alcohol, coniferyl alcohol, and synapyl alcohol. These monolignols are polymerized by a radical coupling process that links them by carbon-carbon or ether bonds. Linkages may occur at any of several different locations on each phenolic unit, causing many different linkage types to be possible.

In accordance with the embodiments described herein, the lignin derivatives are reacted with esterifying agents to produce lignin mixed esters that exhibit unexpected properties. Lignin mixed esters of the present application are characterized by first ester substituents and second ester substituents wherein the first ester substituents are different from the second ester substituents. The lignin mixed esters of the embodiments described herein differ from lignin esters derived by reacting lignin derivatives with a single esterifying agent resulting in a lignin ester that includes only one type of ester substituent. One of the unique properties exhibited by these lignin mixed esters is their thermal glass transition temperatures (T_{g}).

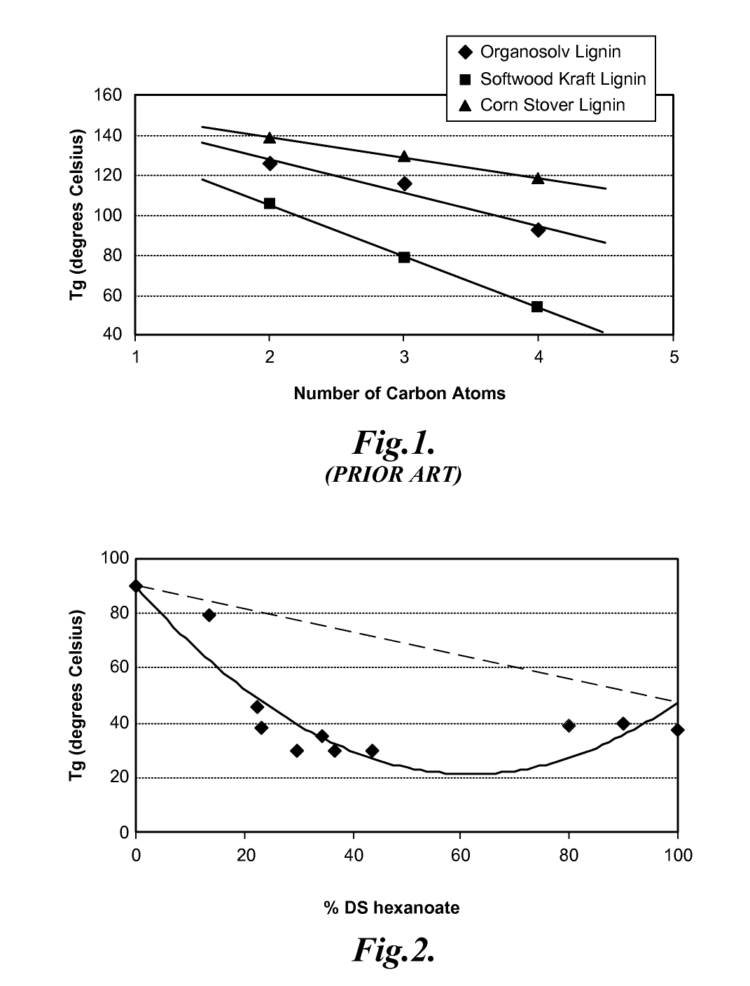

Referring to FIG. 1, Fox, in his Masters of Science thesis entitled “Chemical and Thermal Characterization of Three Industrial Lignins and Their Corresponding Lignin Esters,” reports that as the number of carbon atoms in ester substituents of an organosolv lignin ester, softwood Kraft lignin ester, and corn stover lignin ester increases, the T_{g} decreases linearly. The present inventors have observed that when the difference between the number of carbon atoms in the alkyl substituent of the ester substituents in a lignin mixed ester is 3 or more, the decrease in the T_{g} as ester substituents containing fewer carbon atoms are replaced with ester substituents containing more carbon atoms is greater than is predicted by the linear decrease in T_{g} reported by prior investigators such as Fox.

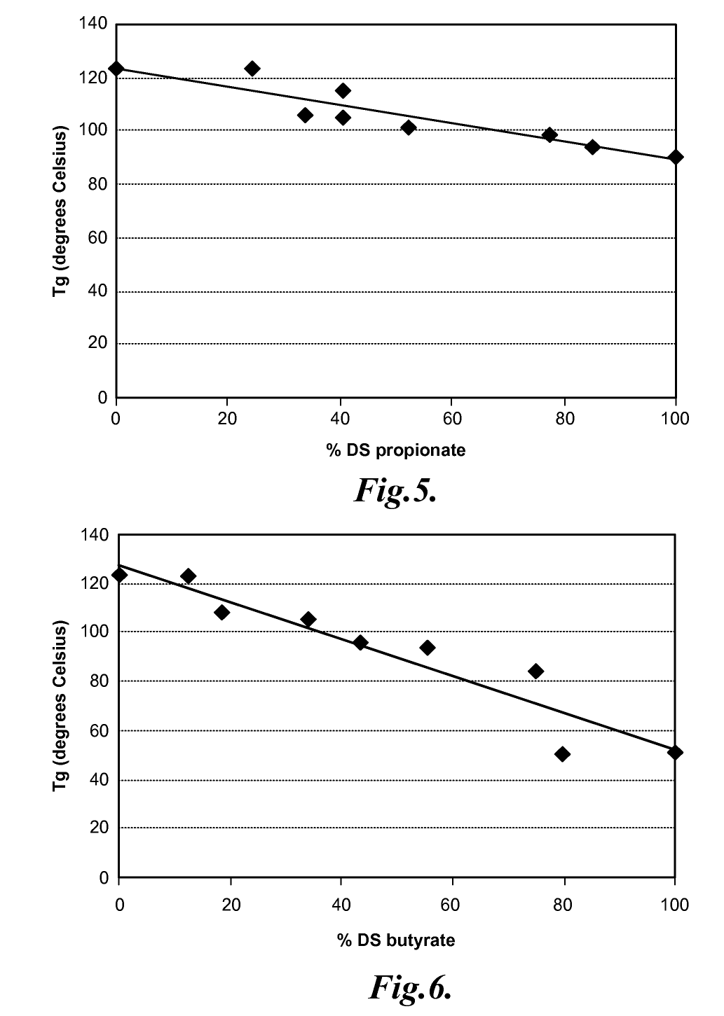

Specifically, turning to FIG. 5, T_{g} values for a lignin acetate propionate mixed ester are illustrated as a function of the % propionate substitution. The number of carbon atoms in the alkyl substituent of the acetate is 1 and the number of carbon atoms in the alkyl substituent of the propionate is 2. Thus, the difference in the number of carbon atoms in the alkyl substituent of acetate and propionate is 1. The plot of FIG. 5 illustrates that when the difference in the number of carbon atoms making up the alkyl substituent of the ester groups present in a lignin mixed ester is less than 3. the T_{g} decreases linearly as the ester with fewer carbon atoms is replaced with an ester containing more carbon atoms.

A similar result is observed for the lignin mixed ester lignin acetate butyrate. FIG. 6 illustrates the T_{g} for lignin acetate butyrate as a function of the % butyrate substitution. The difference in the number of carbon atoms in the alkyl substituent of the acetate ester groups and the butyrate ester groups is 2. Again, as in FIG. 5, FIG. 6 illustrates that as the acetate ester groups are replaced with the butyrate ester groups, the T_{g} decreases linearly.

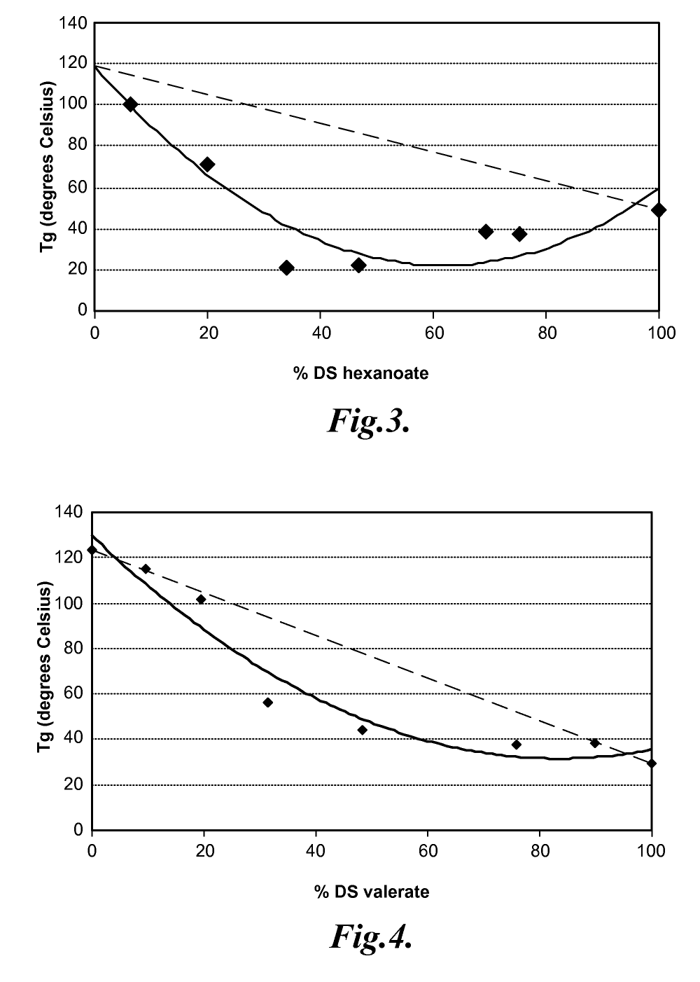

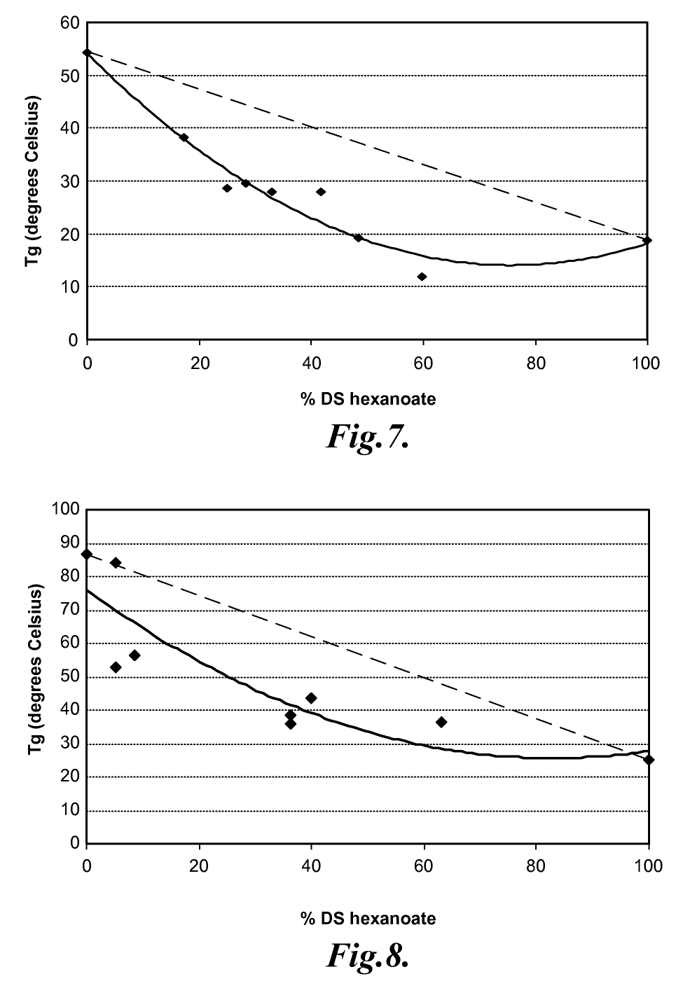

Surprisingly, the present inventors have observed that when the difference in the number of carbon atoms in the alkyl substituent of the ester groups in the lignin mixed ester is 3 or more, the decrease in T_{g} does not follow a linear trend. FIGS. 2, 3, 4, and 7 illustrate T_{g} values for an increasing degree of substitution of one ester group with another ester group having more carbon atoms. Specifically, FIG. 2 plots T_{g} values for Kraft lignin propionate hexanoate. FIG. 3 plots T_{g} values with an increasing degree of hexanoate substitution for Kraft lignin acetate hexanoate. FIG. 4 plots T_{g} values for Kraft lignin acetate valerate mixed ester. FIG. 7 plots T_{g} values for organosolv lignin propionate hexanoate mixed ester. For each of the lignin mixed esters represented in FIGS. 2-4 and 7, the difference in the number of carbon atoms present in the alkyl substituent of the two ester groups of the lignin mixed ester is 3 or more. FIGS. 2-4 and 7 show how the T_{g} values for the noted lignin mixed esters unexpectedly decrease in a nonlinear manner as one ester group is replaced with an ester group that includes more carbon atoms.

In addition, the present inventors have further observed that certain lignin mixed esters of this application exhibit T_{g} values that are less than T_{g} values of a lignin ester that includes the first ester substituents or the second ester substituents, but not both. More specifically, lignin mixed esters of the embodiments described herein include a first group of ester substituents and a second group of ester substituents, wherein the second group of ester substituents includes an alkyl group that has more carbon atoms than the alkyl group of the first ester substituents. The T_{g} of these lignin mixed esters is less than the T_{g} of a lignin ester (derived from the same lignin derivative from which the lignin mixed ester is derived), wherein the ester groups of the lignin ester are all second ester substituents (which have the greater number of carbon atoms).

Lignin esters wherein the ester groups are either first ester substituents or second ester substituents exhibit different T_{g} values, with one having a higher T_{g} than the other. Generally, as represented in FIG. 1, as the number of carbon atoms in the ester group increases, the T_{g} of the lignin ester decreases. Thus, the T_{g} of a lignin ester having a fewer number of carbon atoms in the ester group is generally higher than the T_{g} value for a lignin ester that includes ester substituents having a larger number of carbon atoms. Unexpectedly, lignin mixed esters of the embodiments described herein wherein the ratio of the ester groups containing a fewer number of carbon atoms to the ester groups containing a larger number of carbon atoms fall within specific ranges exhibit T_{g} values that are less than the T_{g} of a lignin ester that contains only the ester substituents containing the larger number of carbon atoms.

An exemplary structure for lignin mixed esters of the embodiments described herein is represented by the following structure:

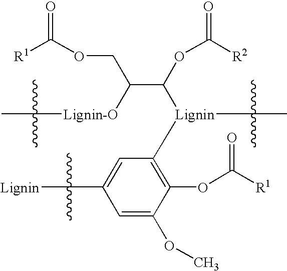

wherein R¹ is C₁ to C₃ alkyl and R² is C₄ to C₁₇ alkyl, and the number of carbon atoms in R² is 3 or more than the number of carbon atoms in R¹. In a preferred embodiment, R¹ is C₁ to C₂ alkyl and R² is C₄ to C₆ alkyl. In a most preferred embodiment, R¹ is C₁ to C₂ alkyl and R² is C₄ or C₅ alkyl. Alkyl as used herein refers to a univalent radical consisting of carbon and hydrogen atoms arranged in a chain. Alkyl groups are derived from members of the alkane series.

Specific examples of R¹ substituents include methyl, ethyl and propyl groups. Specific examples of suitable R² substituents include butyl, pentyl, hexyl through octadecyl groups, with butyl, pentyl and hexyl groups being preferred.

The unexpected thermal glass transition temperature properties of the lignin mixed esters are observed when the degree of esterification of available hydroxyl groups of the lignin derivative is about 100 percent. While it is possible to vary the degree of esterification, when the lignin mixed esters are targeted for blending with thermoplastics where open hydroxyl groups are not desired, it is preferred that the esterification be 100 percent or close thereto.

The lignin mixed esters of the embodiments described herein are further characterized by a ratio of the first ester groups (—OOCR¹) and the second ester groups (—OOCR²) as illustrated by the examples. Kraft lignin propionate hexanoate mixed esters of the embodiments described herein that exhibit a ratio of propionate to hexanoate groups that is less than about 3, exhibit glass transition temperatures that are less than the T_{g} of Kraft lignin hexanoate. Kraft lignin acetate hexanoate having a ratio of acetate to hexanoate that is less than about 2 exhibit T_{g} values that are less than the T_{g} values for Kraft lignin hexanoate. An organosolv lignin propionate hexanoate having a ratio of propionate groups to hexanoate groups of less than about 1 exhibit T_{g} values that are less than the T_{g} value for organosolv lignin hexanoate.

Esterification of lignin derivatives to produce lignin mixed esters can be performed using acid anhydride, acyl chloride and carboxylic acid reactions. Esterification can be carried out typically in the presence of a suitable acid catalyst such as sulfuric acid or zinc chloride, or using a base catalyst such as pyridine, triethylamine, 1-methylimidazole, dimethylaminopyridine (catalyst not necessary). Solvents such as n-methylpyrrolidinone, dimethylsulfoxide, dioxane, or acetone can be used to dissolve the lignin derivative. Concentrations for the lignin derivative in solvent will depend both upon the solvent and the molecular weight of the lignin derivative. Suitable concentrations can range from about zero to 50 weight %, more narrowly 10 to 30 weight %, and preferably about 20 weight %. The esterification reaction can be run at temperatures ranging from room temperature to the boiling point of the solvent. Complete esterification of the lignin derivative can be achieved by conducting the reaction for as little as 15 minutes up to 24 hours. Preferably, the reaction time ranges from about 30 minutes to four hours. Further details of the estrification of lignin derivatives to produce lignin mixed esters of the embodiments described herein are provided in the examples below.

Examples of esterification agents that are useful to produce the lignin mixed esters described herein include propionic anhydride, hexanoic anhydride, acetic anhydride, butyric anhydride, valeric anhydride, hexanoic acid, lauric anhydride, and stearic anhydride.

### Lignin Mixed Ester Synthesis

### EXAMPLE 1

### Lignin Esterification

89.75 g Spruce softwood Kraft lignin was ground to a fine powder with a mortar and pestle before dissolving in 400.0 g n-methylpyrrolidinone (NMP). 20.0 g 1-methylimidazole (22.3 weight percent of lignin) was added to the solution and stirred for five minutes to incorporate. The final concentration of lignin in solution was 17.6 weight percent. 10.4 g aliquots of the stock solution were weighed out in separate vials followed by the addition of an anhydride mixture in varying ratios (see Tables 1-5 below). The vials were briefly shaken before reacting at 60° C. for two hours total. The vials were shaken briefly halfway through the reaction.

After two hours, the reactions were quenched by adding an equal volume of deionized water to the reaction mix. The product was then washed multiple times with water to remove the solvent, catalyst, and reactants. The product was then washed with a 0.5 M solution of sodium bicarbonate to extract any residual acid before being dried in a 105° C. oven.

Sample appearance ranged from light brown powder to dark brown glassy substances. They were all readily soluble in NMP, dimethylsulfoxide (DMSO), chloroform (CHCl₃), and acetone.

TABLE 1
Softwood Kraft Lignin Mixed Ester: Lignin Propionate Hexanoate

| | | Lignin | l-methyl | l-methyl | propionic | propionic | hexanoic | hexanoic |
|---|---|---|---|---|---|---|---|---|
| | Lignin | (mmol) | pyrrolidinone | pyrrolidinone | anhydride | anhydride | anhydride | anhydride |
| | (g) | (C9 unit)* | (g) | (wt. % of lignin) | (g) | (mmoles) | (g) | (mmoles) |
| 1A | 1.83 | 10.3 | 0.407 | 22.2 | 2.57 | 19.8 | 0.62 | 2.89 |
| 1B | 1.83 | 10.3 | 0.407 | 22.2 | 2.2 | 16.9 | 1.24 | 5.8 |
| 1C | 1.83 | 10.3 | 0.408 | 22.3 | 1.82 | 14 | 1.82 | 8.51 |
| 1D | 1.94 | 10.9 | 0.43 | 22.2 | 1.48 | 11.3 | 2.41 | 11.3 |
| 1E | 1.83 | 10.3 | 0.408 | 22.3 | 1.09 | 8.4 | 3.01 | 14 |
| 1F | 1.83 | 10.3 | 0.407 | 22.2 | 0.727 | 5.59 | 3.6 | 16.8 |
| 1G | 1.83 | 10.3 | 0.409 | 22.3 | 0.368 | 2.83 | 4.22 | 19.7 |

C9 unit refers to the phenylpropionic units of lignin (C6C3 group). C9 unit used was 178 g/mol. For softwood Kraft lignin, the average molecular weight of the C9 unit used was 178 g/mol.

TABLE 2
Softwood Kraft Lignin Mixed Ester: Lignin Acetate Propionate

| | | Lignin | l-methyl | l-methyl | acetic | acetic | propionic | propionic |
|---|---|---|---|---|---|---|---|---|
| | Lignin | (mmol) | pyrrolidinone | pyrrolidinone | anhydride | anhydride | anhydride | anhydride |
| | (g) | (C9 unit) | (g) | (wt. % of lignin) | (g) | (mmoles) | (g) | (mmoles) |
| 2A | 1.83 | 10.3 | 0.407 | 22.3 | 2.07 | 20.3 | 0.373 | 0.279 |
| 2B | 1.83 | 10.3 | 0.408 | 22.3 | 1.71 | 16.8 | 0.729 | 0.545 |
| 2C | 1.88 | 10.5 | 0.418 | 22.3 | 1.43 | 14 | 1.1 | 0.805 |
| 2D | 1.83 | 10.2 | 0.407 | 22.3 | 1.15 | 11.3 | 1.48 | 1.11 |
| 2E | 1.85 | 10.4 | 0.412 | 22.3 | 0.893 | 8.75 | 1.84 | 1.36 |
| 2F | 1.83 | 10.3 | 0.408 | 22.3 | 0.573 | 5.61 | 2.19 | 1.64 |
| 2G | 1.83 | 10.3 | 0.408 | 22.3 | 0.306 | 3 | 2.59 | 1.94 |

TABLE 3
Softwood Kraft Lignin Mixed Ester: Lignin Acetate Butyrate

| | | Lignin | l-methyl | l-methyl | acetic | acetic | butyric | butyric |
|---|---|---|---|---|---|---|---|---|
| | Lignin | (mmol) | pyrrolidinone | pyrrolidinone | anhydride | anhydride | anhydride | anhydride |
| | (g) | (C9 unit) | (g) | (wt. % of lignin) | (g) | (mmoles) | (g) | (mmoles) |
| 3A | 1.83 | 10.3 | 0.408 | 22.3 | 2.01 | 19.7 | 0.453 | 2.86 |
| 3B | 1.83 | 10.3 | 0.408 | 22.3 | 1.72 | 16.9 | 0.889 | 5.62 |
| 3C | 1.84 | 10.3 | 0.409 | 22.3 | 1.43 | 14 | 1.35 | 8.55 |
| 3D | 1.83 | 10.3 | 0.407 | 22.3 | 1.14 | 11.2 | 1.77 | 11.2 |
| 3E | 1.83 | 10.3 | 0.408 | 22.3 | 0.87 | 8.52 | 2.22 | 14.5 |
| 3F | 1.84 | 10.3 | 0.409 | 22.3 | 0.56 | 5.32 | 2.67 | 16.9 |
| 3G | 1.83 | 10.3 | 0.408 | 22.3 | 0.29 | 2.76 | 3.11 | 19.7 |

TABLE 4
Softwood Kraft Lignin Mixed Ester: Lignin Acetate Valerate

| | | Lignin | l-methyl | l-methyl | acetic | acetic | valeric | valeric |
|---|---|---|---|---|---|---|---|---|
| | Lignin | (mmol) | pyrrolidinone | pyrrolidinone | anhydride | anhydride | anhydride | anhydride |
| | (g) | (C9 unit) | (g) | (wt. % of lignin) | (g) | (mmoles) | (g) | (mmoles) |
| 4A | 1.83 | 10.3 | 0.407 | 22.3 | 2 | 19.6 | 0.53 | 2.85 |
| 4B | 1.83 | 10.3 | 0.408 | 22.3 | 1.74 | 17 | 1.03 | 5.53 |
| 4C | 1.83 | 10.3 | 0.407 | 22.3 | 1.44 | 14.1 | 1.59 | 8.54 |
| 4D | 1.83 | 10.3 | 0.408 | 22.3 | 1.15 | 11.3 | 2.08 | 11.2 |
| 4E | 1.83 | 10.3 | 0.408 | 22.3 | 0.86 | 8.42 | 2.63 | 14.1 |
| 4F | 1.84 | 10.3 | 0.408 | 22.3 | 0.57 | 5.58 | 3.14 | 16.9 |
| 4G | 1.83 | 10.3 | 0.407 | 22.3 | 0.28 | 2.74 | 3.66 | 19.7 |

TABLE 5
Softwood Kraft Lignin Mixed Ester: Lignin Acetate Hexanoate

| | | Lignin | l-methyl | l-methyl | acetic | acetic | hexanoic | hexanoic |
|---|---|---|---|---|---|---|---|---|
| | Lignin | (mmol) | pyrrolidinone | pyrrolidinone | anhydride | anhydride | anhydride | anhydride |
| | (g) | (C9 unit) | (g) | (wt. % of lignin) | (g) | (mmoles) | (g) | (mmoles) |
| 5A | 1.83 | 10.3 | 0.408 | 22.3 | 2 | 19.6 | 0.59 | 2.75 |
| 5B | 1.83 | 10.3 | 0.407 | 22.3 | 1.89 | 18.5 | 1.19 | 5.55 |
| 5C | 1.83 | 10.3 | 0.408 | 22.3 | 1.44 | 14.1 | 1.8 | 8.4 |
| 5D | 1.84 | 10.3 | 0.41 | 22.3 | 1.16 | 11.4 | 2.39 | 11.2 |
| 5E | 1.84 | 10.3 | 0.41 | 22.3 | 0.86 | 8.42 | 3 | 14 |
| 5F | 1.84 | 10.3 | 0.41 | 22.3 | 0.56 | 5.49 | 3.6 | 16.8 |
| 5G | 1.83 | 10.3 | 0.408 | 22.3 | 0.3 | 2.94 | 4.2 | 19.6 |

Softwood Kraft lignin acetate laurate (LAL) and softwood Kraft lignin acetate stearate (LAS) were synthesized in a manner similar to that of the other mixed esters described above. The concentration of the original solution of lignin n-methylpyrrolidinone was decreased to 10 weight percent but the concentration of 1-methyl imidazole catalyst remained the same at 20 weight percent of lignin. The reactions were run at 60° C. for a total of 4 hours. The reaction mixtures were shaken at the midpoint of the reaction. The lignin mixed esters were precipitated in the same way by adding deionized water to the reaction vial. However, multiple ethanol washes were performed on these long chain mixed esters due to the insolubility of lauric and stearic acids and anhydrides in water. The LAL and LAS samples were not soluble in acetone but still demonstrated high solubility in chloroform. The amounts of lignin, 1-methylpyrrolidinone and anhydrides for LAL and LAS synthesis are summarized in Tables 6 and 7.

TABLE 6
Softwood Kraft Lignin Mixed Ester: Lignin Acetate Laurate

| | Lignin | n-methyl | l-methyl | acetic | acetic | lauric | lauric |
|---|---|---|---|---|---|---|---|
| Lignin | (mmol) | pyrrolidinone | imidazole | anhydride | anhydride | anhydride | anhydride |
| (g) | (C9 unit) | (g) | (g) | (g) | (mmol) | (g) | (mmol) |
| 1 | 0.00564 | 9 | 0.2 | 0.123 | 1.204819277 | 2.085 | 5.449128401 |
| 1 | 0.00562 | 9 | 0.2 | 0.229 | 2.243118817 | 2.155 | 5.63207276 |
| 1 | 0.00562 | 9 | 0.2 | 0.36 | 3.526300323 | 2.188 | 5.718317957 |
| 1 | 0.00562 | 9 | 0.2 | 0 | 0 | 4.26 | 11.13347098 |

TABLE 7
Softwood Kraft Lignin Mixed Ester: Lignin Acetate Stearate

| | Lignin | n-methyl | l-methyl | acetic | acetic | stearic | stearic |
|---|---|---|---|---|---|---|---|
| Lignin | (mmol) | pyrrolidinone | imidazole | anhydride | anhydride | anhydride | anhydride |
| (g) | (C9 unit) | (g) | (g) | (g) | (mmol) | (g) | (mmol) |
| 1 | 0.00562 | 9 | 0.2 | 0.124 | 1.214614556 | 2.87 | 5.209089589 |
| 1 | 0.00562 | 9 | 0.2 | 0.215 | 2.105984915 | 3.019 | 5.479526644 |
| 1 | 0.00562 | 9 | 0.2 | 0.344 | 3.369575864 | 3.091 | 5.610207638 |
| 1 | 0.00562 | 9 | 0.2 | 0 | 0 | 5.889 | 10.68861623 |

### EXAMPLE 2

### Esterification of Organosolv Lignin

17.9 g organosolv lignin (191 g/(mol C9 unit), 93.7 mmoles) was dissolved in 84.3 g n-methylpyrrolidinone (NMP) to give a 17.5 weight percent solution. 3.60 g 1-methylimidazole (20.1 weight percent of lignin) was added to the solution and stirred for five minutes to incorporate. 5.70 g aliquots of the stock solution were weighed out in separate vials followed by the addition of the anhydride mixture in varying ratios (see Tables 6 and 7 below). The vials were briefly shaken before reacting at 65° C. for a total of two hours. The vials were shaken briefly halfway through the reaction.

After two hours, the reactions were quenched by adding an equal volume of deionized water to the reaction mix. The product was then washed multiple times with water to remove the solvent, catalyst, and reactants. The product was then washed with a 0.5 M solution of sodium bicarbonate to extract any residual acid before being dried in a 105° C. oven.

Sample appearance ranged from light brown powder to dark brown glassy substances. The samples were soluble in NMP, dimethylsulfoxide (DMSO), chloroform (CHCl₃), and acetone.

TABLE 8
Organosolv Lignin Mixed Ester: Lignin Propionate Hexanoate

| | | Lignin | l-methyl | l-methyl | propionic | propionic | hexanoic | hexanoic |
|---|---|---|---|---|---|---|---|---|
| | Lignin | (mmol) | imidazole | imidazole | anhydride | anhydride | anhydride | anhydride |
| | (g) | (C9 unit) | (g) | (wt. % of lignin) | (g) | (mmoles) | (g) | (mmoles) |
| 6A | 0.992 | 5.19 | 0.199 | 20.1 | 1.52 | 11.7 | 0 | 0 |
| 6B | 0.993 | 5.20 | 0.199 | 20 | 1.27 | 9.76 | 0.3 | 1.4 |
| 6C | 0.993 | 5.20 | 0.2 | 20.1 | 1.06 | 8.12 | 0.61 | 2.85 |
| 6D | 0.997 | 5.22 | 0.2 | 20.1 | 0.92 | 7.07 | 0.9 | 4.2 |
| 6E | 0.997 | 5.22 | 0.2 | 20.1 | 0.73 | 5.61 | 1.21 | 5.65 |
| 6F | 0.992 | 5.19 | 0.199 | 20.1 | 0.55 | 4.23 | 1.5 | 7 |
| 6G | 0.993 | 5.20 | 0.2 | 20.1 | 0.37 | 2.84 | 1.8 | 8.4 |
| 6H | 0.993 | 5.20 | 0.2 | 20.1 | 0.18 | 1.38 | 2.1 | 9.8 |
| 6I | 0.993 | 5.20 | 0.2 | 20.1 | 0 | 0 | 2.4 | 11.2 |

TABLE 9
Organosolv Lignin Mixed Ester: Lignin Acetate Hexanoate

| | | Lignin | l-methyl | l-methyl | propionic | propionic | hexanoic | hexanoic |
|---|---|---|---|---|---|---|---|---|
| | Lignin | (mmol) | imidazole | imidazole | anhydride | anhydride | anhydride | anhydride |
| | (g) | (C9 unit) | (g) | (wt. % of lignin) | (g) | (mmoles) | (g) | (mmoles) |
| 7A | 0.997 | 5.22 | 0.2 | 20.1 | 1.15 | 11.3 | 0 | 0 |
| 7B | 0.995 | 5.21 | 0.2 | 20.1 | 1.01 | 9.89 | 0.31 | 1.45 |
| 7C | 0.997 | 5.22 | 0.2 | 20.1 | 0.89 | 8.71 | 0.59 | 2.75 |
| 7D | 0.997 | 5.22 | 0.2 | 20.1 | 0.73 | 7.15 | 0.91 | 4.25 |
| 7E | 0.995 | 5.21 | 0.2 | 20.1 | 0.57 | 5.58 | 1.2 | 5.6 |
| 7F | 0.997 | 5.22 | 0.2 | 20.1 | 0.42 | 4.11 | 1.51 | 7.05 |
| 7G | 0.997 | 5.22 | 0.2 | 20.1 | 0.3 | 2.94 | 1.79 | 8.35 |
| 7H | 0.993 | 5.20 | 0.2 | 20.1 | 0.15 | 1.47 | 2.09 | 9.75 |
| 7I | 0.997 | 5.22 | 0.2 | 20.1 | 0 | 0 | 2.4 | 1.12 |

### EXAMPLE 3

### Degree of Substitution of the Lignin Mixed Esters and Ratio of Ester Substituents in Lignin Mixed Esters

The ratio of ester substituents in lignin mixed esters of Example 1 (with the exception of LAL and LAS) and the percent degree of substitution of the same lignin mixed esters of Example 1 (with the exception of LAL and LAS) was determined using Proton Nuclear Magnetic Resonance Spectroscopy (¹H-NMR). ¹H-NMR provides a reliable method for determining the ratio of esters of varying carbon atom content within a lignin mixed ester. The peak for protons on the methoxy unit of lignin occurs at about 3.8 ppm. Using the known values for the methoxy content per C9 unit for the type of lignin used to form the lignin mixed ester, the integration methoxy peak can be set to this known proton value which will essentially calibrate the other peaks in the spectrum.

Using the specific example of a lignin propionate hexanoate mixed ester, the two ester groups are represented as follows:

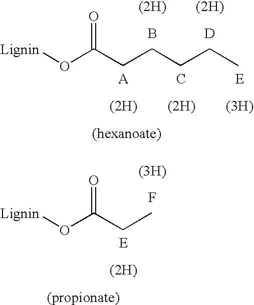

Peaks in the lignin ester ¹H-NMR spectra are all fairly broad due to the amorphous nature of the polymer. The ester functionalities will have different electronic environments depending on where they occur on the lignin polymer. The terminal methyl group of the hexanoyl group (E) can he integrated since the peak stands alone at 0.88-0.92 ppm (I_{E}). The degree of substitution of hexanoate (DSₕₑₓₐₙₒₐₜₑ) can be calculated by dividing the total integration of the peak I_{E} by 3, which takes account for the three protons on the terminal methyl group.

DSₕₑₓₐₙₒₐₜₑ=I_{E}/3 (1)

From the integration for the hexanoyl group, the propionyl substitution can be calculated. The protons for groups A and E fall tinder the peaks in the range of 2.3-2.6 ppm. Taking the total integration of these two peaks from 2.3-2.6 ppm (I_{A,E}) and subtracting the component that is attributed to the two protons from the hexanoyl group, the degree of substitution of the propionyl (DSₚᵣₒₚᵢₒₙₐₜₑ) can be calculated by dividing the remaining integration by two (to represent the two propionyl protons accounted for in the peaks).

DSₚᵣₒₚᵢₒₙₐₜₑ=(I_{A,E}−2*DSₕₑₓₐₙₒₐₜₑ)/2 (2)

A ratio of the DSₚᵣₒₚᵢₒₙₐₜₑ and DSₕₑₓₐₙₒₐₜₑ provides a ratio of propionate to hexanoate substituents in the lignin mixed ester. These values are reported in Table 10 below. The percent degree of substitution was calculated from the degree of substitution values by dividing degree of substitution value for one ester by the sum of the degree of substitution values for the two esters and multiplying by 100. These degrees of substitution values as a percent are also reported in Tables 10 and 16.

The foregoing description also applies to the determination of the degree of substitution and the ratio of ester substituents in lignin mixed esters for lignin acetate hexanoate (LAH) and lignin acetate valerate (LAV) and other higher order mixed esters containing an acetate functionality with a slight variation in the calculation. Since the peak at 2.3-2.6 ppm will now account for the acetate protons, one will need to divide the integration associated with the acetate functionality by 3 as opposed to the 2 previously used.

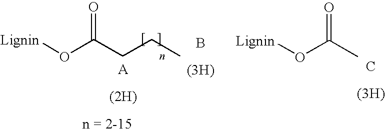

DS_{long chain ester}=I_{B}/3

DS_{acetate}=(I_{A,C}−2*DS_{long chain ester})/3

The degree of substitution and ratio of ester substituents for LAH and LAV are reported in Tables 14 and 13, respectively. Below is described the method for determining the degree of substitution and the ratio of ester substituents in lignin acetate propionate (LAP) and lignin acetate butyrate (LAB).

The method for calculating the DS of LAP and LAB mixed esters is similar in principle to the method used for calculation DS of LAH and LAV. However, the terminal methyl groups in the propionate and butyrate functionalities on these esters have a different shift in the NMR spectrum. The terminal groups for the propionate functionality in the LAP mixed esters occurs as two overlapping peaks at 1.10 and 1.27 ppm whereas the terminal group in the LAB mixed esters occurs at 0.93 and 1.03 ppm. Their closer proximity to the carbonyl group in the ester lends to the fact that the peaks in these shorter chain esters occur further downfield than do the terminal groups in the long ester chains of the LPH, LAV and LAH esters. Another difference that is seen in the terminal methyl peaks in the propionate and butyrate groups is that they consist of two, slightly shifted peaks. Again, since they occur closer to the lignin polymer than do the terminal groups of the longer chain esters, they will have a slightly different shift depending on whether they are attached to an aromatic or aliphatic functionality.

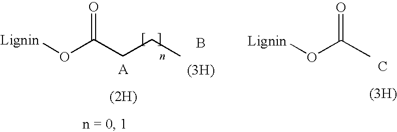

DS_{long chain ester}=I_{B}/3

DS_{acetate}=(I_{A,C}−2*DS_{long chain ester})/3

The degree of substitution for LAP and LAB lignin mixed esters and the ratio of ester substituents calculated therefrom are summarized in Tables 11 and 12, respectively.

### Determination of Glass Transition Temperature

### EXAMPLE 4

The glass transition temperatures for the lignin mixed esters of Example 1 (with the exception of LAS and LAL) were measured on a TA Instrument Q200 digital scanning calorimeter (DSC) using Aluminum T-Zero Hermetic Pans. The method employed cooled the samples at 10° C. per minute from room temperature to −70° C., heated them at 20° C. per minute to 170° C., cooled them at 10° C. per minute to −75° C., and finally heated them at 20° C. per minute to 200° C. Glass transitions were recorded in the second heat cycle and the DSC spectra were obtained and the glass transition temperature determined therefrom. The glass transition (Tg) is found by plotting the heat capacity as a function of temperature. The Tg is a second order endothermic transition, thus seen as a step transition (not a peak). The Tg is calculated at the midpoint of this step transition as recorded by the DSC. The T_{g} values for the various lignin mixed esters are summarized in Tables 10-16.

TABLE 10
Softwood Kraft Lignin Propionate Hexanoate

| | |
|---|---|
| Ratio of | |
| Propionate to | Degree of Substitution |
| Hexanoate Substituents | (%) |

| in Lignin Mixed Ester | Propionate | Hexanoate | T_{g} (° C.) |
|---|---|---|---|
| | 100 | 0 | 89.94 |
| 6.435509 | 86.55102 | 13.44898 | 79.06 |
| 3.472222 | 77.63975 | 22.36025 | 45.49 |
| 3.304348 | 76.76768 | 23.23232 | 37.96 |
| 2.348487 | 70.13577 | 29.86423 | 30.14 |
| 1.919355 | 65.74586 | 34.25414 | 34.8 |
| 1.714072 | 63.155 | 36.845 | 29.94 |
| 1.28685 | 56.27173 | 43.72827 | 30.13 |
| | 0 | 100 | 37.61 |

The T_{g} for softwood Kraft lignin propionate hexanoate as a function of the degree of hexanoate substitution is plotted in FIG. 2. FIG. 2 illustrates that lignin propionate hexanoate mixed esters having a ratio of propionate to hexanoate ester substituents of less than about 3 (˜23% DS hexanoate), exhibit T_{g} values that are less than the T_{g} values for a lignin ester comprising only hexanoate ester substituents. FIG. 2 also illustrates that the T_{g} values for lignin propionate hexanoate fall below the dotted line whose endpoints are defined by the T_{g} of lignin propionate and the T_{g} of lignin hexanoate. The solid line in FIG. 2 is a polynomial curve fit for the T_{g} values as a function of the % hexanoate substitution.

TABLE 11
Softwood Kraft Lignin Acetate Propionate

| | |
|---|---|
| Ratio of | |
| Acetate to Propionate | Degree of Substitution |
| Substituents in Lignin | (%) |

| Mixed Ester | Acetate | Propionate | T_{g} (° C.) |
|---|---|---|---|
| | 100 | 0 | 123.13 |
| 3.137769498 | 75.83239 | 24.16761 | 123.16 |
| 1.472871446 | 59.56118 | 40.43882 | 115.57 |
| 1.977403933 | 66.41369 | 33.58631 | 105.71 |
| 1.46846495 | 59.48899 | 40.51101 | 105.12 |
| 0.913977183 | 47.75277 | 52.24723 | 100.87 |
| 0.288691516 | 22.40191 | 77.59809 | 98.1 |
| 0.177594784 | 15.08115 | 84.91885 | 94.31 |
| | 0 | 100 | 89.94 |

The T_{g} for softwood Kraft lignin acetate propionate mixed esters as a function of the degree of propionate substitution is plotted in FIG. 5. FIG. 5 illustrates that lignin acetate propionate mixed esters do not exhibit T_{g} values that are less than the T_{g} values for a lignin ester comprising only propionate ester substituents. FIG. 5 also illustrates that as the degree of substitution of propionate ester substituent increases, the T_{g} of the mixed ester decreases linearly from the T_{g} of lignin acetate to the T_{g} of lignin propionate. The solid line in FIG. 5 is a linear fit for the T_{g} values as a function of the % propionate substitution.

TABLE 12
Softwood KRAFT Lignin Acetate Butyrate

| | |
|---|---|
| Ratio of | |
| Acetate to Butyrate | Degree of Substitution |
| Substituents in Lignin | (%) |

| Mixed Ester | Acetate | Butyrate | T_{g} (° C.) |
|---|---|---|---|
| | 100 | 0 | 123.13 |
| 7.033333 | 87.55187 | 12.44813 | 122.39 |
| 4.329753 | 81.23741 | 18.76259 | 106.9 |
| 1.911114 | 65.64889 | 34.35111 | 104.44 |
| 1.298853 | 56.50004 | 43.49996 | 95.91 |
| 0.803032 | 44.53787 | 55.46213 | 94.04 |
| 0.333334 | 25.00005 | 74.99995 | 83.55 |
| 0.253687 | 20.23529 | 79.76471 | 49.99 |
| | 0 | 100 | 51.55 |

The T_{g} for softwood Kraft lignin acetate butyrate mixed esters as a function of the degree of butyrate substitution is plotted in FIG. 6. FIG. 6 illustrates that, with the exception of lignin acetate butyrate having a ratio of acetate to butyrate substituents of 0.253687, lignin acetate butyrate mixed esters do not exhibit T_{g} values that are less than the T_{g} values for a lignin ester comprising only butyrate ester substituents. FIG. 6 also illustrates that the decrease in T_{g} values for lignin acetate butyrate as the degree of butyrate substitution increases is substantially linear from the T_{g} value for lignin acetate to the T_{g} value of lignin butyrate. The solid line in FIG. 6 is a linear fit for the T_{g} values as a function of the % butyrate substitution.

TABLE 13
Softwood Kraft Lignin Acetate Valerate

| | |
|---|---|
| Ratio of | |
| Acetate to Valerate | Degree of Substitution |
| Substituents in Lignin | (%) |

| Mixed Ester | Acetate | Valerate | T_{g} (° C.) |
|---|---|---|---|
| | 100 | 0 | 123.13 |
| 9.363184 | 90.35046 | 9.649544 | 115.2 |
| 4.100573 | 80.39436 | 19.60564 | 101.72 |
| 2.185352 | 68.6063 | 31.3937 | 56.4 |
| 1.068398 | 51.65341 | 48.34659 | 44 |
| — | — | — | — |
| 0.320212 | 24.25461 | 75.74539 | 37.53 |
| 0.111857 | 10.06036 | 89.93964 | 38.25 |
| | 0 | 100 | 29.55 |

The T_{g} for softwood Kraft lignin acetate valerate mixed ester as a function of the degree of valerate substitution is plotted in FIG. 4. FIG. 4 illustrates that lignin acetate valerate mixed esters do not exhibit T_{g} values that are less than the T_{g} values for a lignin ester comprising only valerate ester substituents. FIG. 4 illustrates that the T_{g} values for lignin acetate valerate decrease in a nonlinear fashion as the degree of substitution of valerate increases. The dotted line in FIG. 4 extends between the endpoints defined by the T_{g} of lignin acetate and the T_{g} of lignin valerate. The solid line in FIG. 4 is a polynomial curve fit for the T_{g} values as a function of the % valerate substitution.

TABLE 14
Softwood Kraft Lignin Acetate Hexanoate

| | |
|---|---|
| Ratio of | |
| Acetate to Hexanoate | Degree of Substitution |
| Substituents in Lignin | (%) |

| Mixed Ester | Acetate | Hexanoate | T_{g} (° C.) |
|---|---|---|---|
| | 100 | 0 | 123.13 |
| 14.21489 | 93.42749 | 6.572507 | 99.78 |
| 4.015653 | 80.06242 | 19.93758 | 71.47 |
| 1.922129 | 65.77837 | 34.22163 | 20.78 |
| 1.131547 | 53.08573 | 46.91427 | 22.56 |
| 0.43768 | 30.44348 | 69.55652 | 38.19 |
| 0.324167 | 24.48085 | 75.51915 | 37.23 |
| — | — | — | — |
| | 0 | 100 | 49.36 |

The T_{g} for softwood Kraft lignin acetate hexanoate mixed ester as a function of the degree of hexanoate substitution is plotted in FIG. 3. FIG. 3 illustrates that lignin acetate hexanoate mixed esters having a ratio of acetate to hexanoate ester substituents that is less than about 2 (˜34% DSₕₑₓₐₙₒₐₜₑ) exhibit a T_{g} that is less than the T_{g} of a lignin ester comprising only hexanoate ester substituents. FIG. 3 also illustrates how the T_{g} of lignin acetate hexanoate falls below the dotted line whose endpoints are defined by the T_{g} for lignin acetate and the T_{g} of lignin hexanoate. The solid line in FIG. 3 is a polynomial curve fit for the T_{g} values as a function of the % hexanoate substitution.

TABLE 15
Organosolv Lignin Propionate Hexanoate

| | |
|---|---|
| Ratio of | |
| Propionate to | Degree of Substitution |
| Hexanoate Substituents | (%) |

| in Lignin Mixed Ester | Propionate | Hexanoate | T_{g} (° C.) |
|---|---|---|---|
| — | 100 | 0 | 54.25 |
| 4.81 | 82.8 | 17.2 | 38.32 |
| 2.98 | 74.9 | 25.1 | 28.54 |
| 2.55 | 71.8 | 28.2 | 29.43 |
| 2.03 | 67 | 33 | 27.88 |
| 1.40 | 58.4 | 41.6 | 27.98 |
| 1.07 | 51.6 | 48.4 | 19.35 |
| 0.68 | 40.3 | 59.7 | 11.83 |
| — | 0 | 100 | 18.76 |

The T_{g} of the organosolv lignin propionate hexanoate mixed ester as a function of the degree of hexanoate substitution is plotted in FIG. 7. FIG. 7 illustrates that organosolv lignin propionate hexanoate mixed esters having a ratio of propionate to hexanoate ester substituents that is less than about 1 (˜48% DS hexanoate), exhibit a T_{g} that is less than the T_{g} of a lignin ester comprising only hexanoate ester substituents. FIG. 7 also illustrates that the T_{g} for lignin propionate hexanoate falls between the dotted line whose endpoints are defined by the T_{g} for lignin propionate and the T_{g} of lignin hexanoate. The solid line in FIG. 7 is a polynomial curve fit for the T_{g} values as a function of the % hexanoate substitution.

TABLE 16
Organosolv Lignin Acetate Hexanoate

| | |
|---|---|
| Ratio of | |
| Acetate to Hexanoate | Degree of Substitution |
| Substituents in Lignin | (%) |

| Mixed Ester | Acetate | Hexanoate | T_{g} (° C.) |
|---|---|---|---|
| — | 100 | 0 | 86.85 |
| 18.3527451 | 94.83277 | 5.167226 | 84.08 |
| 18.3527451 | 94.83277 | 5.167.226 | 53.06 |
| 10.51532009 | 91.31592 | 8.684083 | 56.66 |
| 1.5131060 | 60.2086 | 39.7914 | 43.73 |
| 1.7641552 | 63.82258 | 36.17742 | 38.49 |
| 1.7576096 | 63.73671 | 36.26329 | 35.78 |
| 0.5866667 | 36.97479 | 63.02521 | 36.43 |
| — | 0 | 100 | 25.19 |

The T_{g} of the organosolv lignin acetate hexanoate mixed ester as a function of the degree of hexanoate substitution is plotted in FIG. 8. FIG. 8 illustrates that organosolv lignin acetate hexanoate mixed esters do not exhibit T_{g} values that are less than the T_{g} values for an organosolve lignin ester comprising only hexanoate ester substituents. FIG. 8 illustrates that the T_{g} values for organosolve lignin acetate hexanoate decrease in a nonlinear fashion as the degree of substitution of hexanoate increases. The dotted line in FIG. 8 extends between the endpoints defined by the T_{g} of organosolv lignin acetate and the T_{g} of organosolv lignin hexanoate. The solid line in FIG. 8 is a polynomial curve fit for the T_{g} values as a function of the percent hexanoate substitution.

Lignin mixed esters exhibiting decreased T_{g} values are attractive candidates for mixing with thermoset and thermoplastic polymers having similar T_{g} values. By replacing ester substituents having a greater number of carbon atoms with ester substituents that have fewer carbon atoms in a lignin mixed ester, cost savings can be achieved because the reactants used to introduce ester groups having fewer carbon atoms into the lignin are less expensive than the reactants needed to introduce ester groups having a greater number of carbon atoms.

While illustrative embodiments have been illustrated and described, it will be appreciated that various changes can be made therein without departing from the spirit and scope of the invention. Aspects of the disclosure described in the context of particular embodiments may be combined or eliminated in other embodiments.

Further, while advantages associated with certain embodiments of the disclosure may have been described in the context of those embodiments, other embodiments may also exhibit such advantages, and not all embodiments need necessarily exhibit such advantages to fall within the scope of the disclosure. Accordingly, the invention is not limited except as by the appended claims.

We claim:

1. A lignin mixed ester derived from a lignin derivative, the lignin mixed ester comprising:
first ester groups represented by the formula —OOCR¹, wherein R¹ is C₁ to C₃ alkyl and second ester groups represented by the formula —OOCR², wherein R² is C₄ to C₁₇ alkyl;
wherein the number of carbon atoms in R² is 3 or more than the number of carbon atoms in R¹ and the ratio of the first ester groups to the second ester groups is less than about 3.

2. The lignin mixed ester of claim 1, wherein R² is C₁ to C₂ alkyl.

3. The lignin mixed ester of claim 2, wherein R² is C₄ to C₆ alkyl.

4. The lignin mixed ester of claim 2, wherein R² is C₄ alkyl.

5. The lignin mixed ester of claim 2, wherein R² is C₅ alkyl.

6. The lignin mixed ester of claim 1, wherein the degree of esterification of the lignin mixed ester is about 100 percent.

7. The lignin mixed ester of claim 1, wherein the lignin derivative is a hardwood Kraft lignin.

8. The lignin mixed ester of claim 1, wherein the lignin derivative is a softwood Kraft lignin.

9. The lignin mixed ester of claim 1, wherein the lignin derivative is an energy crop lignin.

10. The lignin mixed ester of claim 1, wherein T_{g} of the lignin mixed ester is less than T_{g} of a lignin ester having a degree of esterification substantially the same as the degree of esterification as the lignin mixed ester, the lignin ester derived from the lignin derivative, and ester groups of the lignin ester being second ester groups.

11. A process for producing a lignin mixed ester from a lignin derivative comprising:
reacting the lignin derivative with a first esterifying agent to introduce first ester groups represented by the formula —OOCR¹ into the lignin derivative, wherein R¹ is C₁ to C₃ alkyl; and
reacting the lignin derivative with a second esterifying agent to introduce second ester groups represented by the formula —OOCR² into the lignin derivative, wherein R² is C₄ to C₁₇ alkyl;
wherein the number of carbon atoms in R² is 3 or more than the number of carbon atoms in R¹ and the ratio of first ester groups to second ester groups is less than about 3.

12. The process of claim 11, wherein the lignin derivative is a softwood Kraft lignin.

13. The process of claim 11, wherein the lignin derivative is an energy crop lignin.

14. The process of claim 11, wherein R¹ is C₁ to C₂ alkyl.

15. The process of claim 14, wherein R² is C₄ to C₆ alkyl.

16. The process of claim 14, wherein R² is C₄ alkyl.

17. The process of claim 14, wherein R² is C₅ alkyl.

18. The process of claim 11, wherein the degree of esterification of the lignin mixed ester is about 100 percent.

19. The process of claim 11, wherein the lignin derivative is a hardwood Kraft lignin.

20. A Kraft lignin mixed ester derived from a Kraft lignin derivative, the Kraft lignin mixed ester comprising:
first ester groups represented by the formula —OOCR¹, wherein R¹ is C₁ to C₂ alkyl and second ester groups represented by the formula —OOCR², wherein R² is C₅ alkyl;
wherein the ratio of the first ester groups to the second ester groups is less than about 3, the degree of esterification of the Kraft lignin mixed ester is about 100 percent, and T_{g} of the Kraft lignin mixed ester is less than T_{g} of a Kraft lignin ester having a degree of esterification of about 100 percent, derived from the Kraft lignin derivative, and including ester groups, the ester groups of the Kraft lignin ester being second ester groups.

21. A lignin mixed ester derived from a lignin derivative, the lignin mixed ester comprising:
first ester groups represented by the formula —OOCR¹, wherein R¹ is C₁to C₃ alkyl and second ester groups represented by the formula —OOCR², wherein R² is C₄ to C₁₇ alkyl;
wherein the number of carbon atoms in R² is 3 or more than the number of carbon atoms in R¹.

22. The lignin mixed ester of claim 21, wherein R¹ is C₁ to C₂ alkyl.

23. The lignin mixed ester of claim 22, wherein R² is C₄ to C₆ alkyl.

24. The lignin mixed ester of claim 22, wherein R² is C₄ alkyl.

25. The lignin mixed ester of claim 22, wherein R² is C₅ alkyl.

26. The lignin mixed ester of claim 21, wherein the lignin derivative is a hardwood Kraft lignin.

27. The lignin mixed ester of claim 21, wherein the lignin derivative is a softwood Kraft lignin.

28. The lignin mixed ester of claim 21, wherein the lignin derivative is an energy crop lignin.
